(19) United States
(12) Patent Application Publication
(10) Pub. No.: US 2005/0226969 A1
(43) Pub. Date: Oct. 13, 2005

(54) Bagel topping

(76) Inventors: Colin Dugdale, Fishers, IN (US); Caitlin Dugdale, Fishers, IN (US)

Correspondence Address: Woodard, Emhardt, Moriarty, McNett & Henry LLP, Bank One Center/Tower, 111 Monument Circle, Suite 3700, Indianapolis, IN, 46204-5137, US

(21) Appl. No.: 10/822,416

(22) Filed: Apr. 12, 2004

(51) Int. Cl. A23G 3/00

(52) U.S. Cl. 426/143

(57) ABSTRACT

A preformed cream cheese bagel topping for direct application to a slice of a bagel. The bagel topping having an upper and lower surface for engaging a surface of a bagel and a hole extending therebetween.

### BACKGROUND OF THE INVENTION

The present invention relates generally to a topping for a bagel. More particularly, in one form the present invention relates to a preformed cream cheese disk for placement between a sliced bagel.

Bagels are generally recognized as being a toroidally shaped bakery product having a hard outer crust and a softer inner section. Many people enjoy their bagels with cream cheese spread on the cut surfaces of the bagel. A common limitation associated with the spreading of the cream cheese on the cut surfaces of the bagel is that the cream cheese is stored in the refrigerator and as such is cold and difficult to spread until it warms.

There is thus a need for a preformed cream cheese topping that is applied to the surfaces of the bagel without spreading. The present invention satisfies this need in a novel and unobvious way.

### SUMMARY OF THE INVENTION

One form of the present invention contemplates a bagel topping, comprising: a monolithic cream cheese disk having an upper surface and a lower surface with an aperture extending between the surfaces.

Another form of the present invention contemplates a topping, comprising: a cream cheese annular body formed by molding, the body having a first flat bagel abutting surface and a second flat bagel abutting surface spaced from the first flat surface, and wherein the body has a hole between the first flat surface and the second flat surface.

Another form of the present invention contemplates a method of serving a bagel, comprising: separating a bagel into a first bagel shaped portion having a first surface and a second bagel shaped portion having a second surface; placing a preformed single piece cream cheese body having a hole in the center on the first surface, the placing causing one surface of the body to abut the first surface; and, setting the second bagel shaped portion on the other surface of the preformed single piece cream cheese body.

Yet another form of the present invention contemplates a combination comprising: a first bagel slice having a first topping receiving surface; a second bagel slice having a second topping receiving surface; and, a monolithic cream cheese disk having an upper surface and a lower surface with an aperture extending between the surfaces, the disk located between the first bagel slice and the second bagel slice with the upper surface abutting the first topping receiving surface and the lower surface abutting the second topping receiving surface.

One object of the present invention is to provide a unique preformed cream cheese topping.

Related objects and advantages of the present invention will be apparent from the following description.

### BRIEF DESCRIPTION OF THE DRAWINGS

FIG. 1 is an exploded view of one form of the preformed cream cheese topping disposed between halves of a bagel.

FIG. 2 is a sectional view of the bagel of FIG. 1.

FIG. 3 is a plan view of a bagel.

FIG. 4 is an illustrative view of one embodiment of the preformed cream cheese topping within a dispensing wrapper.

### DESCRIPTION OF THE PREFERRED EMBODIMENTS

For purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

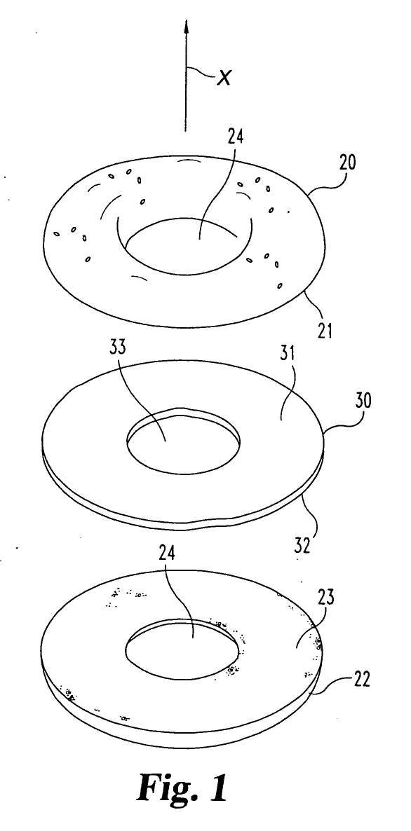

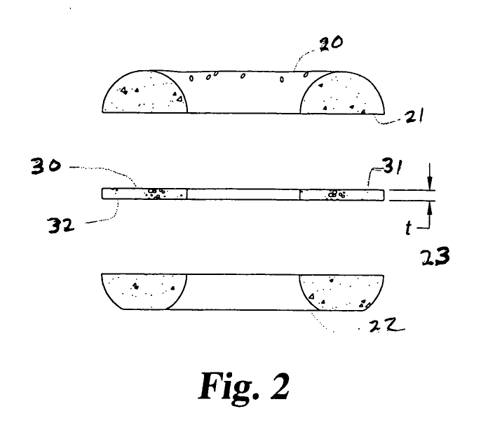

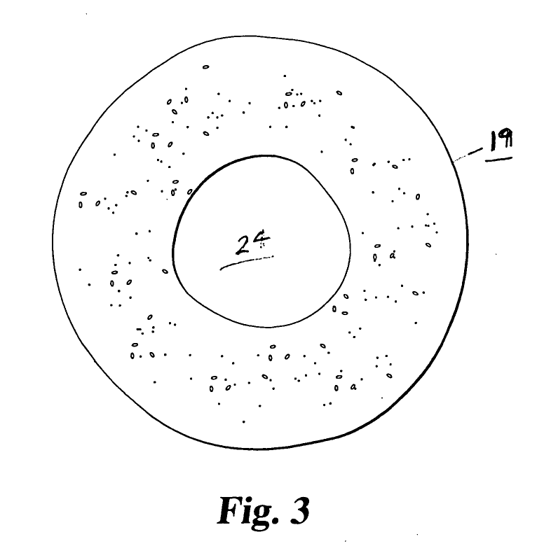

With reference to FIGS. 1-3, there is illustrated a bagel 19 and a cream cheese bagel topping 30. The bagel 19 illustrated in the drawings depicts a conventional toroidal shaped bagel having a substantially central opening 24 extending therethrough. However, the illustrated bagel is not intended to be limiting and therefore bagels contemplated herein may have other geometric shapes, may include an opening of substantially different size or the opening may be blocked or non-existent due to the presence of bagel material. Further, the present application contemplates in an alternative embodiment many types of sandwich breads. The reader should appreciate that the present invention is applicable to all forms of bagels, irrespective of the changes in its geometric shape.

In the present application the term “cream cheese” will be utilized to describe the material that the bagel topping is formed of. The term “cream cheese” as utilized in this application includes, but is not limited to unless provided to the contrary, natural cream cheese, artificial or imitation cream cheese, low calorie cream cheese, low carb cream cheese, and flavored cream cheese. Preferably, the cream cheese contemplated herein has a viscosity at room temperature sufficient to maintain a substantial degree of three-dimensional stability. However, it is recognized that after a period of time of being subjected to elevated temperatures, the cream cheese structure will lose some of its mechanical properties.

Returning to FIG. 1, there is illustrated that bagel 19 has been separated into an upper bagel slice 20 and a lower bagel slice 22. The method of separation may be by cutting, tearing, or other means of separation generally known to those of ordinary skill in the art. Further, the bagel may be manufactured in multiple parts not requiring separation. In the present application, the term “bagel half” may be utilized. The term bagel half is not intended to be limited herein to an actual literal half, but rather contemplates that the bagel is divided into two separated portions. The terms “bagel halves” or “bagel slice” refer to a bagel portion that is created by separating the bagel across its width on a plane generally perpendicular to the axis X of the bagel 19.

In one form of the present invention, the bagel 19 is toroidal shaped. However, other shapes, including, but not limited to, circular, polygonal, and square are contemplated here. Upper bagel slice 20 includes an upper bagel receiving surface 21, and the lower bagel slice 22 includes a lower bagel receiving surface 23. The opening 24 in the bagel 19 extends between the upper bagel receiving surface 21 and the lower bagel receiving surface 23. In one form of the present invention, the opening 24 extends along and around the longitudinal axis X. However, bagels having no opening 24 or alternatively configured openings are contemplated herein.

Bagel topping 30 defines a cream cheese body including an upper surface 31 and a lower surface 32 spaced apart by a thickness “t”. The thickness “t” is within a range of about 1/8- 3/8 inch, and in one form is about 1/4 inch. However other thicknesses are contemplated herein. The upper surface 31 is adapted to abut an upper bagel receiving surface 21 and the lower surface 32 is adapted to abut the lower bagel receiving surface 23. The present application further contemplates that while the bagel topping includes an upper surface and a lower surface they do not both have to be placed in engagement with a portion of a bagel. For example, in one embodiment contemplated herein only one of the upper surface and lower surface of the bagel topping contacts the bagel.

In one form of the present invention the surface 31 and 32 are substantially flat. However, the present invention also contemplates that the surface 31 and 32 may be other than flat. Further, the present invention contemplates that surface 31 and 32 are substantially parallel to one another. Additionally, the present application contemplates that the surfaces 31 and 32 may be other than parallel to one another.

The bagel topping 30 has an outer periphery that may be, but is not limited to, bagel shaped, tororidal shaped, circular, polygonical, oblique or square. Formed within the bagel topping 30 is a hole 33 that extends through the main body between the surface 31 and the surface 32. The hole 33 is shown in FIG. 1, as being substantially coaxial with the periphery of the bagel topping 30. However, other relationships between the location of the hole 31 and the periphery of the bagel topping 30 are contemplated herein. The bagel topping 30 is preferably a single piece, however, the present application contemplates that the bagel topping main body may be formed from a plurality of abutting main body portions. Each of the main body portions include a part of the surfaces 31 and 32. The group of abutting main body portions are placed in an abutting relationship to form a bagel topping.

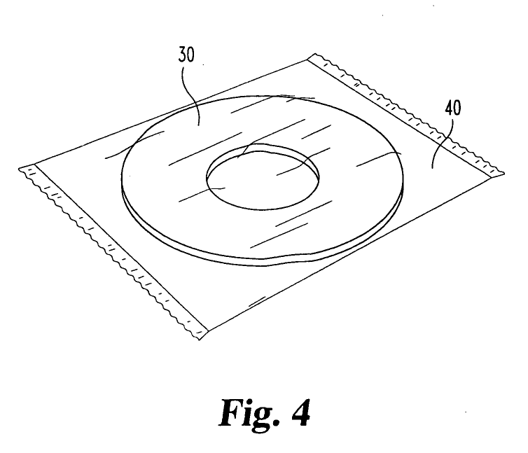

With reference to FIG. 4, there is illustrated one embodiment of the bagel topping 30 disposed within a wrapper 40. The wrapper 40 may be separate or linked to other bagel toppings 30 by a separation or frangible seam. Further, the bagel toppings 30 may be dispensed from other types of storage devices known to those of skill in the art.

The bagel topping 30 is contemplated as being manufactured as a single piece preformed unit. In another form, the present application contemplates the bagel topping being sliced from a bulk preformed body. Methods to manufacture the preformed topping 30 include casting/molding and slicing. In a preferred form the bagel topping 30 will be formed by molding. The formation of the bagel topping is preferably done separate and apart from the bagel. More specifically, the bagel toppings are not formed insitu on the slices of the bagels. However, it is recognized that the bagel topping could be manipulated on the bagel after being placed betweed the bagel slices.

The bagel topping 30 is contemplated as being removed from any packaging/wrapping and placed upon one of the halves of the bagel. The other half of the bagel may than be placed on the other side of the bagel topping to form a bagel with cream cheese their between.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow. In reading the claims it is intended that when words such as “a,” “an,” “at least one,” “at least a portion” are used there is no intention to limit the claim to only one item unless specifically stated to the contrary in the claim. Further, when the language “at least a portion” and/or “a portion” is used the item may include a portion and/or the entire item unless specifically stated to the contrary.

1. A bagel topping, comprising:
a monolithic cream cheese disk having an upper surface and a lower surface with an aperture extending between said surfaces.

2. The bagel topping of claim 1, wherein said disk is not formed insitu on a bagel.

3. The bagel topping of claim 1, wherein said disk has a centerline, and wherein said aperture is formed around said centerline.

4. The bagel topping of claim 1, wherein said disk has a circular periphery.

5. The bagel topping of claim 1, wherein said disk has a polygonal periphery.

6. The bagel topping of claim 1, wherein said disk has a periphery corresponding to a bagel shape.

7. The bagel topping of claim 1, wherein said upper surface and said lower surface are substantially flat, and wherein said upper surface is adapted to abut a surface of a first bagel slice and said lower surface is adapted to abut a surface of a second bagel slice.

8. The bagel topping of claim 1, wherein said disk has a thickness within a range of about 1/8 inch to about 3/8 inch.

9. The bagel topping of claim 1, wherein said disk is formed of an artificial cream cheese material.

10. The bagel topping of claim 1, wherein said disk has a substantially stable three-dimensional shape.

11. The bagel topping of claim 1, wherein said disk has a centerline;
wherein said aperture is formed around and along said centerline;
wherein said upper surface and said lower surface are substantially flat and parallel to one another;
wherein said upper surface is adapted to abut a surface of a first bagel slice and said lower surface is adapted to abut a surface of a second bagel slice; and
wherein said disk is formed separate and apart from said bagel.

12. The bagel of claim 11, wherein said disk is formed by casting in a mold.

13. The bagel of claim 1, wherein said disk is cast.

14. A topping, comprising:
a cream cheese annular body formed by molding, said body having a first flat bagel abutting surface and a second flat bagel abutting surface spaced from said first flat surface, and wherein said body has a hole between said first flat surface and said second flat surface.

15. The topping of claim 14, wherein said body defines a single piece ring.

16. The topping of claim 14, wherein said body includes a plurality of ring portions abutting one another to define a ring.

17. The topping of claim 14, wherein said body has a substantially circular periphery and said hole is circular, and wherein said periphery and said hole are coaxial.

18. The topping of claim 14, wherein said body is a single piece structure sized to be received on a bagel for consumption by a human, and wherein said body is a plate with said hole located substantially central in said plate.

19. The topping of claim 14, wherein said body is molded in a mold and separate from a bagel surface.

20. A method of serving a bagel, comprising:
separating a bagel into a first bagel shaped portion having a first surface and a second bagel shaped portion having a second surface;
placing a preformed single piece cream cheese body having a hole in the center on the first surface, said placing causes one surface of the body to abut the first surface; and
setting the second bagel shaped portion on the other surface of the preformed single piece cream cheese body.

21. The method of claim 20, which further includes unwrapping said body prior to said placing.

22. The method of claim 20, wherein said placing forms a cream cheese layer without performing any spreading act.

23. A combination comprising:
a first bagel slice having a first topping receiving surface;
a second bagel slice having a second topping receiving surface; and
a monolithic cream cheese disk having an upper surface and a lower surface with an aperture extending between said surfaces, said disk located between said first bagel slice and said second bagel slice with said upper surface abutting said first topping receiving surface and said lower surface abutting said second topping receiving surface.

24. The combination of claim 23, wherein said disk is formed independently of said bagel slices.

25. The combination of claim 23, wherein said disk substantially covers said topping receiving surfaces.
